(19) United States
(12) Patent Application Publication
(10) Pub. No.: US 2007/0021543 A1
(43) Pub. Date: Jan. 25, 2007

(54) Fiber for hair use improved in curling property and head decoration product comprising the same

(76) Inventor: Toshiyuki Masuda, Takasago-shi (JP)

Correspondence Address: BRINKS HOFER GILSON & LIONE, P.O. BOX 10395, CHICAGO, IL, 60610, US

(21) Appl. No.: 10/575,842

(22) PCT Filed: Oct. 8, 2004
(86) PCT No.: PCT/JP04/15329

§ 371 Date: Apr. 13, 2006

(30) Foreign Application Priority Data
Oct. 17, 2003 (JP) 2003-358312

(51) Int. Cl. C08K 5/02

(52) U.S. Cl. 524/412

(57) ABSTRACT

Fibers for hair use in which the drawback of curling property is imparted without imparting features of human hair, such as flame resistance, heat resistance, touch feeling, and which are reduced in quality unevenness. The fibers are a bundle of fibers for hair use which comprises a mixture of 10 to 90 parts by weight of human hair (A) and 90 to 10 parts by weight of polyester fibers (B) having an LOI-value of at least 25, a thermal shrinkage ratio at 180° C. of at most 5%, and a single fiber fineness of 20 to 100 dtex, wherein the component (B) is polyester fibers formed from a composition obtained by melt-kneading a polyalkylene-ethylene terephthalate and a copolymer comprising polyalkylene-ethylene terephthalate as the main component (C) together with a phosphorus compound flame retardant (D) and/or a bromine compound flame retardant (E).

### TECHNICAL FIELD

The present invention relates to a head decoration product used as a wig or a hair accessory, and to a fiber for hair use improved in curling property and a head decoration product comprising the same.

### BACKGROUND ART

Human hair is expensive compared with a synthetic fiber and there is limitation on an amount in use and a length thereof, however, from a view point of its excellent features, human hair has been used for a head decoration product as a raw material for hair use so far. As a raw material substituted for human hair, synthetic fibers such as acrylic fibers, vinyl chloride fibers, and polyester fibers are used, but the synthetic fiber has not reached obtaining the natural tactility and gloss that human hair has, thus being in the situation where they can not be completely used as a substitute. On the other hand, human hair has a eater absorbing property compared with synthetic fibers, subsequently, it has a problem that a curl is easily drawn and its diameter becomes large when human hair absorbs water. In particular, a large curl is drawn due to its own weight to become almost straight after absorbing water. Further, currently used human hair takes many treatment steps, starting from eliminating cuticles with a chemical treatment, such as sterilization, decoloring, dyeing and imparting luster before applied to a head decoration product, therefore, human hair may be damaged in some cases during these steps, and in addition, human hair has differences among human races or individuals in terms with thickness, hardness, length etc and the quality is not maintained uniformly all the time, and the present situation is that human hair is not necessarily considered to be assured as a raw material for a factory product whose quality should be guaranteed.

In order to improve such drawback of curling feature that human hair has and the unevenness of the quality, a process of mixing synthetic fibers excellent in curling property into human hair is considered. However, human hair have several excellent properties such as flame resistance and heat resistance, in addition to properties such as excellent texture, difficulty in fritz and easiness in cutting, and it is necessary no tot disqualify those properties. For example, in the case of human hair, generally, steam setting at least 100° C. or setting by a hair iron at least 160° C. is considered to impart a curl. At this time, human hair can fix a style without cooling and can be styled without taking time and labor after styling by a hair iron.

On the other hand, acrylic fibers and vinyl chloride fibers are excellent in flame resistance, but low in heat resistance compared with human hair, and setting by a hair iron is limited at about 150° C. If setting is performed higher than the temperature, shrinkage or frizz are caused, however human hair is usually set at about 180° C., thus, acrylic fibers and vinyl chloride fibers cannot be used in a mixing state with human hair (JP-A-2002-235256). Also, a process of mixing polyester fibers with human hair is proposed (Japanese Registered Utility Model No. 3021160), but general polyester fibers are easily combusted, consequently a mixture thereof with human hair becomes easily combusted, and there is a problem in terms of safety as a head decoration product. Although polyester fibers imparted with flame resistance are also developed, which are mainly drip-extinguished, they also lack safety as a head decoration product. Also, although polyester fibers which are easily set at a low temperature in the same manner as acrylic fibers and vinyl chloride fibers are developed as the fibers for hair use and used largely, in the case of using by mixing with human hair, shrinkage or frizz are caused if performing setting under the condition suitable for human hair since heat resistance is lowered. Furthermore, when imparting a style by using a hair iron, in synthetic fiber, after performing styling with the hair iron, this hair-iron is removed in order to make the style fixed, an amount of time for cooling the hair holding the curl for several minutes by a had etc is necessary (the curl is drawn in the used synthetic fiber unless being cooled due to thermoplasticity), cooling must be performed every time at treating with a hair iron, which takes a large amount of labor, thus not being practical.

In this manner, a synthetic fiber improves in its drawbacks and capable of performing setting under the condition suitable for human hair without damaging the above described excellent properties of human hair has been expected.

### DISCLOSURE OF INVENTION

The present invention has an object to provide fibers for hair use in which the drawback of curling property is improved without imparting features of human hair, such as flame resistance, heat resistance, touch feeling, and which are reduced in quality unevenness.

As the result of intensive studies conducted repeatedly in order to solve the above described problems, the present inventors found a process of using polyester fibers having both heat resistance and flame resistance and mixing the fiber into human hair at an appropriate ratio and reached the completion of the present invention.

Namely, the present invention relates to a fiber bundle for hair use comprising a mixture of 10 to 90 parts by weight of human hair (A) and 90 to 10 parts by weight of polyester fibers (B) having an LOI-value of at least 25, a thermal shrinkage ratio at 180° C. of at most 5%, and a single fiber fineness of 20 to 100 dtex, preferably the component (B) is polyester fibers formed from a composition obtained by melt-kneading polyalkylene terephthalate and copolymered polyester comprising polyalkylene terephthalate as the main component (C) with a phosphorus flame retardant (D) and/or a bromine flame retardant (E), preferably the component (C) is at least one polymer selected from the group consisting of polyethylene terephthalate, polypropylene terephthalate, polybutylene terephthalate, a polyester which is copolymerized with ethylene glycol ether of bisphenol-A, a polyester which is copolymerized with 1,4-cyclohexane dimethanol, a polyester which is copolymerized with dihydroxyethyl 5-sodium sulfoisophthalate, a polymer alloy of polyethylene terephthalate and polyethylene naphthalate, a polymer alloy of polyethylene terephthalate and polyarylate, and a polymer alloy of polyethylene terephthalate and polycarbonate,

the component (D) is at least one compound selected from the group consisting of a phosphate compound, phosphonate compound, phosphynate compound, phosphine oxide compound, a phosphonite compound, a phosphinite compound, a phosphine compound, condensed phosphoric ester compound, a phosphoric ester amide compound, and organic cyclic phosphorus compound, and

the component (E) is at least one compound selected from the group consisting of bromine-containing phosphoric ester flame retardant, brominated polystyrene flame retardant, brominated benzylacrylate flame retardant, brominated epoxy flame retardant, brominated polycarbonate flame retardant, derivative of tetrabromobisphenol-A, bromine-containing triazine compound, and bromine-containing isocyanuric acid compound.

Further, the present invention relates to a fiber bundle for hair use, wherein said component (B) has fine projections on the surface of the fiber comprising a mixture of organic fine particles (F) and/or inorganic fine particles (G), the component (F) is at least one selected from the group consisting of polyacrylate, polyamide, fluorine resin, a silicon resin, a crosslinked acrylic resin, and crosslinked polystyrene, and the component (G) is at least one selected from the group consisting of calcium carbonate, silicon oxide, titanium oxide, aluminum oxide, zinc oxide, talc, kaolin, montmorillonite, bentonite, and mica.

The present invention further relates to a head decoration product, which is obtained by processing the fiber bundle for hair, and preferably relates to a head decoration product, which are a wig or a hair accessory.

According to the present invention, a head decoration product can be obtained, which is improved in the drawbacks of human hair such that curling becomes weak after absorbing water, a curl diameter becomes large, and curling is likely to be drawn with shampoo, without damaging properties of human hair, such as flame resistance, heat resistance, soft touch feeling, and natural gloss, and, further ability to impart a curl with a hair iron without cooling, and which is easily applied to a style with large curls and has a neater style.

Human hair (A) used in the present invention is not particularly limited, and commercially available human hair can be used. Commercially available human hair pieces are subjected to washing, elimination of the cuticle, decoloring and dyeing treatment etc, and a silicone finishing agent is used therein in order to ensure touch feeling and processability, the flame resistance inherent to human hair is not maintained. Accordingly, in order to obtain a fiber bundle for hair use having flame resistance and a head decoration product that comprising the same, it is necessary to blend a fiber having high flame resistance.

The polyester fiber (B) used in the fiber bundle for hair use of the present invention has an LOI-value of at least 25 and a thermal shrinkage ratio of at 180° C. of at most 5% and a single fiber fineness of 20 to 100 dtex. When the LOI-value of the polyester fiber (B) is les than 25, the fiber gradually becomes liable to burn, and besides that, a risk of burn is generated by melt-dripping at combustion. Also, when a thermal shrinkage ratio at 180° C. of the polyester fiber (B) is more than 5%, frizz and shrinkage occur by steam setting at 100° C. or more and by a treatment with a hair iron at 160° C. or less.

The above-described thermal shrinkage ratio is obtained by measuring a thermal shrinkage ratio from a room temperature to a melting point at a speed of increasing a temperature of 2 to 20° C./min and, applying a load of at most 10 mg/dtex by a thermal-mechanical analyzer generally used for a thermal analysis. However, since the value fluctuates depending on the load and the speed of increasing a temperature, a thermal shrinkage ratio refers to a value in the case where the load is set to be 5.55 mg/dtex and the rate of increasing a temperature is set to be 3° C./min in the present invention.

The fineness of one fiber of the polyester fiber (B) is 20 to 100 dtex, preferably 30 to 90 dtex, and more preferably 40 to 80 dtex. If the fineness is less than 20 dtex, the fiber is too soft as the use for hair and styling is difficult, and is more than 100 dtex, the fiber tends to become hard.

The polyester fiber (B) used in the present invention is preferred to be the polyester (C) represented by polyethylene terephthalate. The fineness of one fiber of the polyester fiber (B) is 20 to 100 dtex, preferably 30 to 90 dtex, and more preferably 40 to 80 dtex. If the fineness is less than 20 dtex, the fiber is too soft as a use for hair and styling is difficult, and is more than 100 dtex, the fiber tends to become hard.

The fineness of one fiber of the polyester fiber (B) is 20 to 100 dtex, preferably 30 to 90 dtex, more preferably 40 to 80 dtex. If the fineness is less than 20 dtex, the fiber is too soft as a use for hair and styling is difficult, and if more than 100 dtex, the fiber tends to become hard.

For example, a fiber comprising a composition obtained by melt-kneading a phosphorus flame retardant (D) and/or a bromine flame retardant (E), and a fiber comprising a polyester copolymerized with a reactive phosphorus flame retardant thereto can be used, and it is preferable to use a polyester fiber having not only flame resistance and heat resistance, but also difficulty in dripping at combustion and natural luster similar to human hair which is moderately degrossed.

As polyalkylene terephthalate and a copolymered polyester comprising polyalkylene terephthalate as the main component (C) used in the present invention, examples are polyalkylene terephthalate such as polyethylene terephthalate, polypropylene terephthalate and polybutylene terephthalate, and/or a copolymered polyester comprising these polyalkylene terephthalates as the main component and a small amount of copolymer components, and a polymer alloy of polyarylate, polycarbonate therewith, and the like.

The above wording, the main component, is referred to as comprising at least 80% by mol.

As the above-described copolymer components, examples are multiple carbonic acid such as isophthalic acid, orthophthalic acid, naphthalene dicarboxylic acid, paraphenylene dicarboxylic acid, trimellitic acid, pyromellitic acid, succinic acid, glutaric acid, adipic acid, sberic acid, azelaic acid, sebacic acid, and dodecanedicarboxylic acid and derivatives thereof,

dicarboxylic acid containing sulfonate salt such as 5-sodium sulfoisophthalic acid and dihydroxyethyl 5-sodium sulfoisophthalate, and derivatives thereof, and 1,2-propanediol, 1,3-propanediol, 1,4-butanediol, 1,6-hexanediol, neopentyl glycol, 1,4-cyclohexane dimethanol, diethylene glycol, polyethylene glycol, trimethylol propane, pentaerythritol, 4-hydroxybenzoic acid, ε-caprolactone and the like.

Is preferable to prepare the above copolymered polyester generally by reacting a polymer of terephthalic acid and/or derivatives thereof (for example, methyl terephthalate), and alkylene glycol, which is the main component with a small amount of a copolymer component from the viewpoints of stability and simplicity in operation, but the above copolymered polyester may be prepared by polymerizing a mixture containing further a small amount of a monomer or an oligomer, which is a copolymer component, into a mixture of terephthalic acid and/or derivatives thereof (for example, methyl terephthalate), which is to be the main component, and alkylene glycol.

As for the copolymered polyester, the above copolymer component may be polycondensed to the main chain and/or the side chain of polyalkylene terephthalate, which is the main component, and there is no particular limitation for a copolymerization process.

Specific examples of the copolymerized polyester in which the the above-described polyalkylene terephthalate which is the main component are a polyester copolymerized with an ethylene glycol ester of a bisphenol-A, in which polyethylene terephthalate is the main component, a polyester which is copolymerized with 1,4-cyclohexane dimethanol, and a polyester which is copolymerized with dihydroxyethyl 5-sodium sulfoisophthalate.

The above-described polyalkylene terephthalate and copolymerized polyesters thereof may be used with one kind or may be used in combination of at least two kinds. Among these, polyethylene terephthalate, polypropylene terephthalate, polybutylene terephthalate, and copolymered polyester (such as a polyester copolymerized with an ethylene glycol ether of a bisphenol-A, in which polyethylene terephthalate is the main component, a polyester copolymerized with 1,4-cyclohexane dimethanol, and a polyester copolymerized with dihydroxyethyl 5-sodium sulfoisophthalate) are preferable, and a mixture of at least two kinds of these is also preferable.

The inherent viscosity of the component (C) is preferably 0.5 to 1.4, and more preferably 0.6 to 1.2. When the inherent viscosity is less than 0.5, mechanical strength of the obtained fiber tends to become lower, and when more than 1.4, the melt-viscosity becomes high along with increasing the molecular weight, it tends that the melt-spinning becomes difficult, or the fineness becomes uneven.

The phosphorus flame retardant (D) used in the present invention is not particularly limited, and generally used flame retardants can be used, and examples are a phosphate compound, a phosphonate compound, a phosphinate compound, a phosphine oxide compound, a phosphonite compound, a phosphinite compound, a phosphine compound, a condensed phosphoric ester compound, a phosphoric ester amide compound, and an organic cyclic phosphorus compound. These may be used solely or may be used in combination of at least two kinds.

Concrete examples of the above-described component (D) are trimethyl phosphate, triethyl phosphate, tributyl phosphate, tri(2-ethyl hexyl)phosphate, triphenyl phosphate, tricresyl phosphate, trixylenyl phosphate, tris(isopropylphenyl)phosphate, tris(phenylphenyl)phosphate, trinaphthyl phosphate, cresylphenyl phosphate, xylenyldiphenyl phosphate, triphenyl phosphine oxide, tricresyl phosphine oxide, diphenyl methane phosphonate, and diethyl phenyl phosphonate, and besides these, resorcinol poly(di-2,6-xylyl)phosphate, bisphenol-A polycresyl phosphate, hydroquinone poly(2,6-xylyl)phosphate.

As for a condensed phosphate ester compound, a phosphate ester amide compound and an organic cyclic phosphorus compound, examples are a condensed phosphate ester compound represented by the general formula (1), a phosphate ester amide compound represented by the general formula (2), and an organic cyclic phosphorus compound represented by the general formula (3): 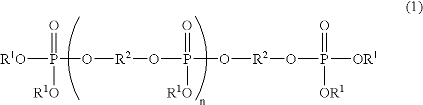
(wherein R¹ represents a monovalent aromatic hydrocarbon group or an aliphatic hydrocarbon group, and each of them may be the same or different. R² represents a bivalent aromatic hydrocarbon group, and when at least two bivalent aromatic hydrocarbon groups are contained, they may be the same or different. n represents an integer of 0 to 15), 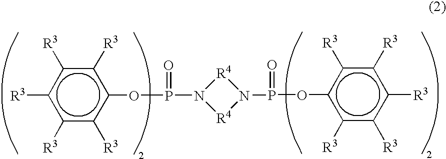
(wherein R³ represents a hydrogen atom, an alkyl group having straight chain or a branched chain, and each of them may be the same or different. R⁴ represents a bivalent alkylene group having a straight chain or a branched chain, a hydroxyalkyl group having a straight chain or a branched chain, a cycloalkylene group, an alkylene group having an ether oxygen in the main chain, a substituted or non-substituted aryl group, or a substituted or non-substituted aralkyl group, and each of them may be the same or different), 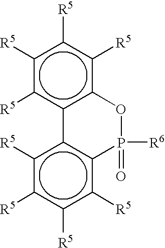
(wherein R⁵ represents a hydrogen atom, an alkyl group having a straight chain or a branched chain, and each of them may be the same or different. R⁶ represents a hydrogen atom, an alkyl group having a straight chain or a branched chain, a hydroxyalkyl group having a straight chain or a branched chain, a cycloalkyl group, a substituted or non-substituted aryl group, or a substituted or non-substituted aralkyl group).

Concrete examples are condensed phosphate ester compounds represented by the general formula (1) and the like, 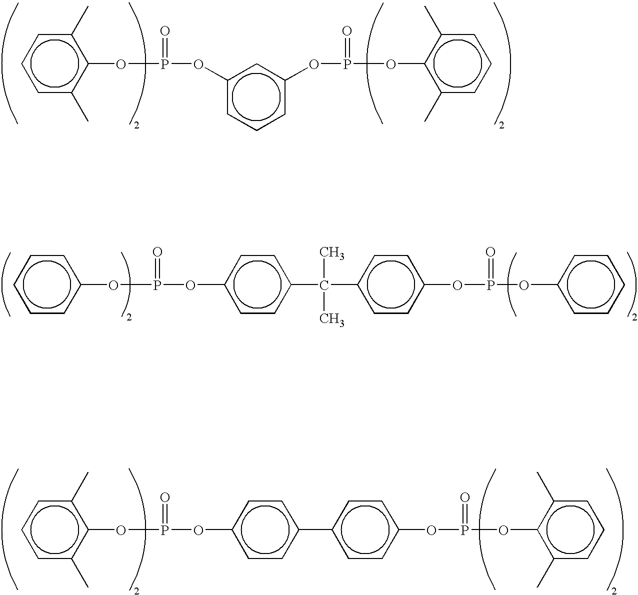
a phosphate ester amide compound represented by the general formula (2) and the like: 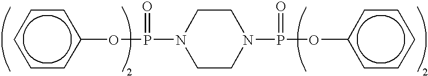
and an organic cyclic phosphoric compound represented by the general formula (3) and the like.

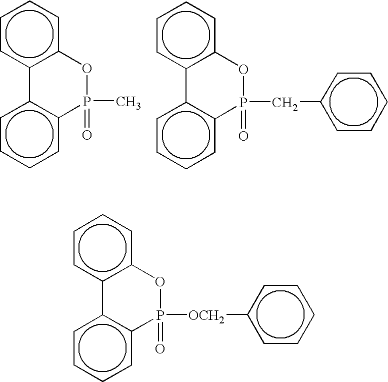

The amount of the above-described component (D) to be used is preferably 3 to 30 parts by weight, more preferably it is 4 o 25 parts by weight, and further more preferably 5 to 20 parts by weight based on 100 parts by weight of the component (C). If the amount is less than 3 parts by weight, the effect of flame resistance is hardly obtained, and if more than 30 parts by weight, mechanical properties, heat resistance and drip resistance are damaged.

The bromine flame retardant (E) used in the present invention has no particularly limited, and generally used bromine flame retardants can be employed. Examples are bromine-containing phosphate esters, brominated polystyrenes, brominated polybenzyl acrylates, brominated epoxy oligomers, brominated polycarbonate oligomers, derivatives of tetrabromobisphenol-A, bromine-containing triazine compounds, and bromine-containing isocyanuric acid compounds. These may be used alone or at least two kinds thereof may be used in combination.

Concrete examples of the above-described component (E) are bromine-containing phosphate esters such as pentabromotoluene, hexabromobenzene, decabromobiphenyl, a decabromodiphenyl ether, bis(tribromophenoxy)ethane, a tetrabromophthalic anhydride, ethylene bis(tetrabromophthalimide), ethylene bis(pentabromophenyl), octabromotrimethylphenylindane, and tris(tribromoneopentyl)phosphate; brominated polystyrenes such as a compound represented by the following formula: 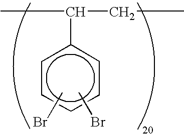
brominated polybenzyl acrylates such as a compound represented by the following formula: 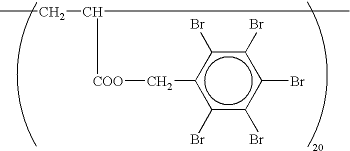
brominated epoxy oligomers such as a compound represented by the following formula: 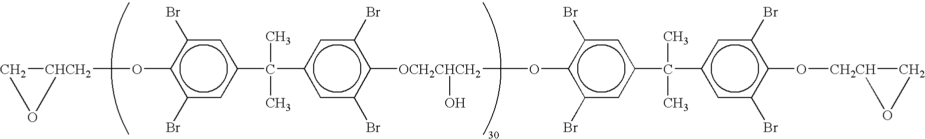
brominated polycarbonate oligomers such as a compound represented by the following formula: 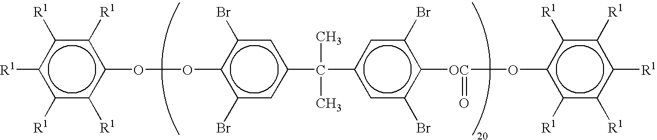
derivatives of tetrabromobisphenol-A such as tetrabromobisphenol-A, tetrabromobisphenol-A-bis(2,3-dibromopropyl ether), tetrabromobisphenol-A-bis(allyl ether), and tetrabromobisphenol-A-bis(hydroxyethyl ether); bromine-containing triazine compounds such as tris(tribromophenoxy)triazine; and bromine-containing isocyanuric acid compounds such as tris(2,3-dibromopropyl)isocyanurate.

Among these, a bromine-containing phosphate ester flame retardant, a brominated polystyrene flame retardant, a brominated benzyl acrylate flame retardant, a brominated epoxy flame retardant, a brominated polycarbonate flame retardant, a derivative of tetrabromobis phenol-A, a bromine-containing triazine compound, and a bromine-containing isocyanuric acid compound are preferable.

The amount of the above-described component (E) is preferably it is 2 to 30 parts by weight, more preferably 3 to 25 parts by weight, and, further more preferably it is 4 to 20 parts by weight based on 100 parts by weight of the component (C). If the amount is less than 2 parts by weight, the effect of flame resistance is hardly obtained, and if more than 30 parts by weight, mechanical properties, heat resistance and drip resistance are gamaged.

In the flame-retardant polyester fiber for artificial hair use according to the present invention, the luster and gloss on the surface of the fiber can be adjusted by mixing organic fine particles (F) and/or inorganic fine particles (G) to form fine projections on the surface of the fiber.

As the component (F), an organic resin component having a structure which is not soluble with the component (C) or not soluble with the component (D) and/or the component (E), or not partially soluble therewith can be used. Examples are polyarylate, polyamide, a fluorine resin, a silicon resin, a crosslinked acrylic resin and crosslinked polystyrene. There may be used alone or at least two kinds thereof may be used in combination.

As the component (G), it is preferable to use a component having a refractive index near to the refractive index with the component (C), the component (D) and/or the component (E) in view of the transparency of the fiber and the color development thereof, and examples are calcium carbonate, silicon oxide, titanium oxide, aluminum oxide, zinc oxide, talc, kaolin, montmorillonite, bentonite, and mica.

The polyester fibers used for the present invention can be prepared by previously dry-blending the component (C) and the component (D) and/or the component (E), and further, if necessary, the component (F) and/or the component (G), thereafter melt-kneading the mixture by using various kinds of general kneaders.

Examples of the kneaders are a single screw extruder, a twin screw extruder, a roll, a Banbury mixer and a kneader. Among these, a twin screw extruder is preferable from the viewpoints of adjustment of a degree of kneading and simplicity in the operation.

The flame retardant polyester fiber for artificial hair use of the present invention can be prepared by melt-spinning the above-described flame retardant polyester composition with a general melt-spinning process.

Namely, for example, temperatures of an extruder, a gear pump, a spinning cap etc are set at 250 to 310° C., melt-spinning is performed, and the extruded yarn is passed through a heating tube, thereafter, cooled to at most a glass transition point and drawn up at a speed of 50 to 5000 m/min to obtain an extruded yarn. It is also possible to control the fineness by cooling the extruded yarn in a water bath containing water for cooling. A temperature and a length of the heating tube, a temperature and an amount of blowing of cooling wind, a temperature of the cooling bath, a cooling time, and a drawing speed can be suitably be adjusted according to an amount of discharge and the number of openings of the spinnerets.

The obtained undrawn yarn is thermally drawn, and drawing may be carried out by either of the two-step process, in which the undrawn yarn is taken up once then drawn, or the direct-spinning drawing process, in which the undrawn yarn is continuously drawn without taking up. Thermal drawing is carried out by a single-stage drawing process or a multiple-stage drawing process having at least two stages. As means for heating in thermal drawing, a heating roller, a heat plate, a steam jet apparatus, a hot water bath and the like can be used, and these can be suitably combined to use.

Various additives such as heat resistant agent, a photostabilizer, a fluorescent agent, an antioxidant, an antistatic agent, a pigment, a plasticizer, and a lubricant may be contained in the polyester fiber (B) in the present invention according to the necessity. Spun-dyed fibers can be obtained by containing a pigment.

When the polyester fiber (B) of the present invention is spun-dyed, it can be used as it is, and when the polyester fiber (B) is not spun-dyed, it can be dyed under the same conditions as ordinary flame retardation polyester fibers.

As the pigment, the dye, the auxiliary agent etc used for dyeing, ones having excellent weather resistance and flame resistance are preferable.

The polyester fiber (B) of the present invention is excellent in curl setting property using a beauty thermal apparatus (a hair iron) and also excellent in holdability of curl. Also, since it is moderately deglossed due to the unevenness on the surface of the fibers, it can be used as an artificial hair. Further, the fiber can become more similar to human hair by using oil solutions such as a fiber-surface treating agent and a softener to impart the touch feeling and the texture.

The fiber bundle of the present invention is a mixture of the above-described human hair (A) and the polyester fiber (B). The mixing ratio between the human hair (A) and the polyester fiber (B) is selected suitably by required qualities for various styles, however, a rage of the mixing ratio is the component (A)/the component (B)=90 parts by weight/10 parts by weight to 10 parts by weight/90 parts by weight, preferably 85 parts by weight/15 parts by weight to 15 parts by weight/85 parts by weight, and more preferably 80 parts by weight/20 parts by weight to 20 parts by weight/80 parts by weight.

When the mixing ratio of (B) is less than 10 parts by weight or the mixing ratio of (A) is more than 90 parts by weight, properties such that the setting property is weak at absorbing water, a curl diameter is large and curls are drawn with a shampoo, which are drawbacks of human hair, can not be improved. When the mixing ratio of (B) is more than 90 parts by weight or the mixing ratio of (A) is less than 10 parts by weight, properties such as natural touch feeling and the unnecessity of a cooling time for fixing a style at a treatment with a hair iron, which are excellent features to human hair, are damaged.

As a head decoration product obtained by processing the fiber bundle for hair use of the present invention, concretely, examples are head decoration products such as a wig, a blade, a hair accessory and hair for a doll's head, and particularly, a wig and a hair accessory are preferable.

The wig is deferred to a decoration item mainly for enjoying dressing-up, which is wore on a head part with the surface, regardless of ladies' use or men's use, and is classified into a partial wig, half wig, a three-quarter wig, and a full wig according to an applied area thereof.

On the other hand, the hair accessory is refereed to a generic name for decorative items except for a wig attached to human hair or a scalp. Examples are an extension which is attached to human hair via a hair pin, a hair clip or the like to look like longer hair, and a weaving which is sewn to human hair by weaving in the form of a mesh along a scalp, or is attached on a scalp or human hair by using an adhesive etc mainly as a band shape (including fibers which are simply bundles, a fiber bundle processed into the shape of a weft hair, which is generally called as a weft by a person skilled in the art, and a decorative item wherein a shape of a curl is imparted thereto).

A process for processing those head decoration products by using the fiber bundle for hair use of the present invention can be carried out by known preparation processes. For example, in the case of manufacturing a wig, it can be prepared by making a straw hair by sewing with a sewing machine for a wig made of the fiber bundle, winding the straw hair around a pipe to impart curls by steam setting, then sawing hair around with curls onto arranging a style.

### BEST MODE FOR CARRYING OUT THE INVENTION

Next, the present invention is further concretely explained in details based on Examples, but is not limited thereto.

The evaluation processes in Examples are described in the following. Unless particularly mentioned, the following thermal shrinkage, an LOI-value and drip resistance are evaluated with respect to a fiber (filament) used in Examples and Comparative Examples, and flame resistance, a treatment with a hair iron and necessity or unnecessity of cooling, steam setting, touch feeling etc are evaluated with respect to a fiber bundle which is prepared.

(Thermal Shrinkage)

A thermal shrinkage ratio of filaments is measured using an SSC5200H thermal analyzer TMA/SS150C manufactured by Seiko Instruments Inc. 10 pieces of filaments having a length of 10 mm are adopted, and a load of 5.55 mg/dtex is applied thereto. The thermal shrinkage ratio of the filaments is measured at a speed of temperature increase of 3° C./min in a range of 30 to 280° C., and a thermal shrinkage ratio at 180° C. is evaluated.

(Limiting Oxygen Index, LOI-Value)

16 cm/0.25 g of filaments is weighted, and the both ends of the filaments are lightly bundled with a double-stick tape, and the filaments are pinched and then twisted with a twist device. After the filaments are sufficiently twisted, they are folded in two right at the middle of the sample, and the resulting two filaments are twisted together. Then, the ends of the filaments are stuck with a sellotape (registered trademark) so that the entire length becomes 7 cm. The filaments are pre-dried at 105° C. for 60 minutes, and further dried in a desiccator for at least 30 minutes. The dried sample is adjusted to have the specified oxygen concentration, after 40 seconds, the sample is ignited from the upper part with an igniter restricted to 8 to 12 mm, and, the igniter is separated away after ignition. An oxygen concentration at which the sample is burned by at least 5 cm or continues to be burned for at least 3 minutes is examined. The test is repeatedly conducted three times under the same conditions to obtain a limiting oxygen index (LOI-value). The larger the LOI-value is, the less the sample is burned, and the higher the flame resistance is.

(Drip Resistance)

Filaments having a fineness of about 50 dtex are cut into a length of 150 mm, 0.7 g of the filaments are bundled, one end thereof is pinched with a clamp to fix to a stand, and the bundle is vertically hung down. The fixed filament having the effective length of 120 mm is contacted with flame of 20 mm for 30 seconds to burn the filament, and the number of drips is counted until the fire is extinguished. The evaluation is conducted, assuming the number of drips of 0 as ⊚, the number of drips of at most 5 as ◯, the number of drips of 6 to 10 as Δ, and the number of drips of at least 11 as X.

(Flame Resistance)

Filaments having a fineness of about 50 dtex are cut into a length of 150 mm, 0.7 g of the filaments are bundled, one end thereof is pinched with a clamp to fix to a stand, and the bundle is vertically hung down. The fixed filament having the effective length of 120 mm is contacted with flame of 20 mm for 3 seconds, the combustion time is measured after the fire is away, and the evaluation is conducted, assuming the combustion time of less than 1 second as ⊚, from 1 to less than 5 seconds as ◯, from 5 seconds to less than 8 seconds as Δ, and at least 8 seconds as X.

(Iron Setting Property)

The iron setting property represents easiness in curl setting by a hair iron and an index of the holdability for a shape of curl. Filaments were preheated by being lightly sandwiched and rubber by a hair iron heated at 180° C. three times. Fusion among the filaments at this time, combing, shrinkage in the filament, and yarn breakage are evaluated with the visual observation. Subsequently, the pre-heated filament is wound around the hair iron, and maintained for 10 seconds, and the iron is drawn off. The easiness in drawing the iron (rod-out property) and holdability for curl when the iron is drawn are evaluated with the visual observation.

(Necessity/Unnecessity of Cooling at a Treatment with a Hair Iron)

A fiber bundle having a length of 45 cm and the total fineness of about 150,000 dtex is folded in two, and one end of the fiber bundle is bundled to make a sample. This fiber bundle is fixed to a mannequin head used for a test to be hung down and the fiber bundle is taken up from the fiber tips by a hair iron, thereafter, the hair iron is drawn out to impart curling. Regarding a sample in which curling is maintained as it is, it is determined that cooling is unnecessary. Regarding a sample in which the curl is drawn away at this time, it is determined that cooling is necessary.

(Steam Setting)

A fiber bundle having a length of 30 cm and the total fineness of about 50,000 dtex is spirally wound around a 25 mm φ aluminum pipe, and fixed with a rubber band, thereafter, the fiber bundle is inserted into a high-pressure sterilization apparatus (manufactured by HIRAYAMA MANUFACTURING CORPORATION), the apparatus is sealed up, raising the temperature to 120° C. by generating steam, then set for 1 hour after the temperature reaches 120° C. After cooling, the fiber bundle is taken off from the pipe and is immersed into water for 5 minutes so as to absorb water, then one end of the fiber bundle which is curled is fixed and hung down after removing water on the surface with a filter paper. As for setting property, a length immediately after hanging down (the initial length of the fiber bundle without curling before setting is 25 cm) is measured. As for shampoo durability, the fiber bundle is dried as it is kept hanging, and a length is measured after immersing into water again to absorb water three times. Respectively, the larger the measured value becomes, it indicates that the longer the curling becomes, and when the length is 25 cm, it indicates that the curling is lost and the fiber bundle becomes straight. Regarding a curl diameter, the internal diameter of the curled fiber bundle is measured immediately after the above-described set absorption of water.

(Touch Feeling)

The sensory evaluation is conducted by a professional hairstylist, and evaluated based on the standard having three stages, ◯: very soft texture similar to human hair, Δ: relatively hard texture compared with human hair, and X: hard texture compared with human hair.

(Beauty Properties)

A fiber bundle is formed into a straw hair and is wound around a 60 mm φ pipe, and set with steam at 120° C. to impart curls. Then, the straw hair with curling is sewn to a hair cap to prepare a wig of a short bobbed hair style, and evaluations are conducted by a professional hair stylist with respect to holdability for curl at an end of hair, curl stability, straightness property at the middle part of hair, adaptability to styles, touch feelings of the commercial product and combing performance. The holdability for curl at an end of hair is evaluated in the viewpoint of whether or not the curl necessary to the style is imparted to the end of hair and shape thereof is maintained, and also whether or not shape thereof is maintained even after sufficiently absorbing water by spray etc and then drying. The curl stability is evaluated in the viewpoint of whether or not a style is being maintained at the time of shaking the commercial product in a practical range. The straightness property at the middle part of hair is evaluated according to whether or not appearance of curl at the middle part which is unnecessary for styling is suppressed. The touch feeling of the commercial product is evaluate in the viewpoint of whether or not the fiber bundle has a touchness (neither too hard nor too soft) similar to human hair and also there appears an unnatural roughness. Combing is evaluated in the viewpoint of whether or not combing can be smoothly performed.

### PREPARATION EXAMPLES 1 to 10

After compositions having the ratio shown in Table 1 were dried to contain an amount of water of at most 100 ppm, 2 parts of polyester pellet for coloring PESTM6100 BLACK (available from Dainichiseika Color & Chemicals Mfg. Co. Ltd., an amount of carbon black is 30%) was added and dry-blended, and the mixture was supplied to a twin screw extruder, and melt-kneaded at 280° C. to be pelletized, thereafter, dried to have a water amount of at most 100 ppm. Subsequently, a molten polymer was discharged from the spinneret by using an eyeglass type nozzle shown in FIG. 1 with a molten fiber spinner at 280° C. The fiber was cooled in a water bath having a temperature of 50° C., which was installed at a position of 30 mm below the spinneret, then, an undrawn yarn was obtained by taking up at the speed of 100 m/min. The obtained undrawn yarn was drawn in a warm water bath at 80° C. to form a four-fold drawn yarn. Then, using a heat roll heated at 200° C., the yarn was taken up at a speed of 100 m/min, a heat treatment was conducted to obtain a polyester fiber (multi-filament) having a single fiber fineness of approximately 65 dtex. A PO/EO random polyether (weight average molecular weight: 20000) and 0.05% omf of a cation antistatic agent were applied to the obtained polyester fiber.

TABLE 1

| | | Preparation Examples | | | | | | | | | |
|---|---|---|---|---|---|---|---|---|---|---|---|
| | | 1 | 2 | 3 | 4 | 5 | 6 | 7 | 8 | 9 | 10 |
| (C) | polyethylene terephthalate A *¹ | 100 | 100 | 100 | 85 | 100 | 100 | 100 | 100 | 70 | 100 |
| | polybutylene terephthalate B *² | | | | | | | | | 30 | |
| | polyethylene terephthalate/ | | | | 15 | | | | | | |
| | polyarylate alloy *³ | | | | | | | | | | |
| (D) | phosphorus flame retardant A *⁴ | 10 | | | | | | | 5 | | |
| | phosphorus flame retardant B *⁵ | | 10 | | | | | | | | |
| | phosphorus flame retardant C *⁶ | | | 8 | 8 | | | | | | |
| (E) | bromine flame retardant A *⁷ | | | | | 8 | | | | | |
| | bromine flame retardant B *⁸ | | | | | | 12 | 12 | | 12 | 12 |
| (F) | polyarylate *⁹ | | | | | | | 0.5 | | | |
| (G) | PKP-53 *¹⁰ | 1 | 0.5 | 0.6 | 0.6 | 1 | 0.5 | | 1 | 0.6 | 0.6 |
| | IMSIL A-8 *¹¹ | 1 | 0.5 | 0.6 | | | 0.5 | | 1 | 0.3 | |

| | | | | | | | | | | |
|---|---|---|---|---|---|---|---|---|---|---|
| single fiber fineness (dtex) | 67 | 65 | 67 | 66 | 65 | 66 | 67 | 66 | 65 | 110 |
| LOI-value | 26 | 27 | 27 | 28 | 29 | 29 | 29 | 23 | 28 | 29 |
| thermal shrinkage ratio at 180° C. | 3 | 2 | 2 | 3 | 3 | 3 | 2 | 2 | 9 | 3 |
| drip resistance | ◯ | ◯ | ⊚ | ⊚ | ⊚ | ⊚ | ⊚ | ◯ | Δ | ⊚ |

| | |
|---|---|
| *¹: | BELLPET EFG-85A, available from Kanebo Gohsen, Ltd. |
| *²: | BELLPET EFG-10, available from Kanebo Gohsen, Ltd. |
| *³: | U-polymerU-4025, available from UNITIKA, Ltd. |
| *⁴: | PX-200, available from Daihachi Chemical Industry Co., Ltd. |
| *⁵: | 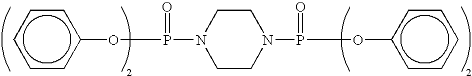 |
| *⁶: | 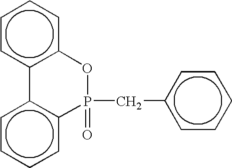 |
| *⁷: | CR-900, available from Daihachi Chemical Industry Co., Ltd. |
| *⁸: | SR-T20000, available from SAKAMOTO YAKUHIN KOGYO CO., LTD. |
| *⁹: | U-polymerU-100, available from UNITIKA, Ltd. |
| *¹⁰: | PKP-53, available from Fuji Talc Kogyo Co., Ltd. |
| *¹¹: | IMSIL A-8, available from UNIMIN CORPORATION |

Regarding the polyester fiber obtained in Preparation Examples 1 to 7 and Comparative Preparation Examples 1, the results of evaluating a single fiber fineness, a thermal shrinkage ratio at 180° C. and drip resistance are shown (Table 1).

### EXAMPLES 1 to 12

The polyester fibers in Preparation Examples 1 to 7 and a commercially available human hair having a fineness of 68 dtex were mixed at the ratio shown in Table 2, and hackling was carried out to form a shape of a yarn.

TABLE 2

Examples

| | | 1 | 2 | 3 | 4 | 5 | 6 | 7 | 8 | 9 | 10 | 11 | 12 |
|---|---|---|---|---|---|---|---|---|---|---|---|---|---|
| (A) | human hair | 30 | 30 | 15 | 30 | 50 | 30 | 30 | 15 | 30 | 50 | 70 | 30 |
| (B) | Preparation Example 1 | 70 | | | | | | | | | | | |
| | Preparation Example 2 | | 70 | | | | | | | | | | |
| | Preparation Example 3 | | | 85 | 70 | 50 | | | | | | | |
| | Preparation Example 4 | | | | | | 70 | | | | | | |
| | Preparation Example 5 | | | | | | | 70 | | | | | |
| | Preparation Example 6 | | | | | | | | 85 | 70 | 50 | 30 | |
| | Preparation Example 7 | | | | | | | | | | | | 70 |

By using this fiber bundle, according to the above-described evaluation process, results of evaluating flame resistance, steam setting property (setting property, curl diameter, and shampoo durability), necessity or unnecessity of cooling at setting with a hair iron, and touch feeling are shown in Table 3. Further, the fiber bundle was made into straw hair and wound around a pipe having a diameter of 60 mm® to impart curls by steam setting at 120° C., then, the straw hair with curling is sewn to a hair cap to prepare a wig of short bobbed hair style. The results of evaluating the beauty properties are show in Table 3.

TABLE 3

| | Examples | | | | | |
|---|---|---|---|---|---|---|
| | 1 | 2 | 3 | 4 | 5 | 6 |
| flame retardancy | ∘ | ∘ | ⊚ | ⊚ | ∘ | ⊚ |
| steam set (120 ° C.) | | | | | | |
| setting property | 13.5 | 12.0 | 11.0 | 12.0 | 14.0 | 13.0 |
| curl diameter | 2.7 | 2.5 | 2.4 | 2.5 | 2.7 | 2.5 |
| shampoo | 14.5 | 13.5 | 12.0 | 13.0 | 15.0 | 13.5 |
| iron setting property (180° C.) | | | | | | |
| necessity/unnecessity of | unnecessity | unnecessity | necessity | unnecessity | unnecessity | unnecessity |
| cooling at hair iron | | | | | | |
| touch feeling | ∘ | ∘ | ∘ | ∘ | ∘ | ∘ |
| beauty properties | | | | | | |
| curl holdability at an end of hair | ⊚ | ⊚ | ⊚ | ⊚ | ⊚ | ⊚ |
| curl stability | ∘ | ∘ | ∘ | ∘ | ⊚ | ∘ |
| straightness at the middle part | ∘ | ∘ | Δ | ∘ | ⊚ | ∘ |
| style adaptability | ∘ | ∘ | ∘ | ∘ | ⊚ | ∘ |
| texture of the product | ∘ | ∘ | Δ | ∘ | ⊚ | ∘ |
| combing property | ⊚ | ⊚ | ⊚ | ⊚ | ⊚ | ⊚ |

### COMPARATIVE EXAMPLES 1 to 7

A commercially available polyester fiber (Artlon made in Nanchang, an LOI-value: 20, a thermal shrinkage ratio at 180° C.: 11%, and drip resistance: x), the fineness in Preparation Examples 8 to 10, a commercially available human hair having a fineness of 68 dtex were mixed at the ratio shown in Table 4, and hackling was carried out to from a shape of a yarn.

TABLE 4

| | | Comparative Examples | | | | | | |
|---|---|---|---|---|---|---|---|---|
| | | 1 | 2 | 3 | 4 | 5 | 6 | 7 |
| (A) | human hair | | 30 | 50 | 100 | 30 | 30 | 30 |
| (B) | Artlon | 100 | 70 | 50 | | | | |
| | Preparation Example 8 | | | | | 70 | | |
| | Preparation Example 9 | | | | | | 70 | |
| | Preparation Example 10 | | | | | | | 70 |

By using this fiber bundle, according to the above-described evaluation process, results of evaluating flame resistance, steam setting property (setting property, curl diameter and shampoo durability), necessity or unnecessity of cooling at setting with a hair iron are shown in Table 5. Further, a wig of a short bob style was prepared in the same manner as Examples, and the results of evaluating beauty properties are shown in Table 5.

TABLE 5

| | Comparative Examples | | | | | | |
|---|---|---|---|---|---|---|---|
| | 1 | 2 | 3 | 4 | 5 | 6 | 7 |
| flame retardancy | × | × | × | ∘ | × | ∘ | ⊚ |
| steam set (120° C.) | | | | | | | |
| setting property | 13.0 | 14.0 | 115.0 | 20.0 | 113.0 | 18.0 | 12.0 |
| curl diameter | 2.6 | 2.8 | 2.9 | 4.1 | 2.5 | 2.5 | 3.1 |
| shampoo | 14.0 | 15.0 | 16.0 | 22.5 | 14.0 | 20.0 | 12.9 |
| iron setting property (180° C.) | × | × | × | ∘ | ∘ | ∘ | ∘ |
| necessity/unnecessity of | — | — | — | unnecessity | unnecessity | necessity | unnecessity |
| cooling at hair iron | | | | | | | |
| touch feeling | × | × | Δ | ∘ | ∘ | ∘ | × |
| beauty property | | | | | | | |
| curl holdability at an end of hair | ⊚ | ∘ | ∘ | × | ⊚ | Δ | ∘ |
| curl stability | × | × | Δ | Δ | ∘ | Δ | ∘ |
| straightness at the middle part | × | × | Δ | ⊚ | Δ | ∘ | × |
| style adaptability | × | × | Δ | × | ∘ | ∘ | × |
| texture of the product | Δ | Δ | ∘ | ⊚ | Δ | ∘ | × |
| combing property | Δ | Δ | ∘ | ⊚ | ∘ | ∘ | ∘ |

### INDUSTRIAL APPLICABILITY

As shown in Tables 3 and 5, it was confirmed that heat shrinkage, an LOI-value, drip resistance, combustibility, steam setting properties (setting property, curl diameter, and shampoo durability), necessity or unnecessity of cooling at setting with a hair iron are excellent in the Examples, compared with Comparative Examples. Also, in Examples, the straightness property at the middle part is excellent as human hair, the arrangement of the hair faces are neat; and touch feeling and combing are smooth, and also the shape of curl is maintained even after absorbing water compared with human hair; thus, curl stability and adaptability become excellent to finish to obtain a beautiful style. Accordingly, it is confirmed that the fiber bundle for hair of the present invention in which 90 to 10 parts by weight of the polyester fiber (B) of the present invention, to which flame resistance is imparted, and 10 to 90 parts by weight of human hair (A) are mixed, can be used as fibers for hair use and a head decoration product comprising the same, in which the drawback of curling property is improved without imparting features of human hair, such as flame resistance, heat resistance, touch feeling, and which are reduced in quality unevenness, compared with a fiber bundle for hair use in which a conventional non flame resistant polyester fiber and human hair are mixed.

1. A fiber bundle for hair use comprising a mixture of 10 to 90 parts by weight of human hair (A) and 90 to 10 parts by weight of polyester fibers (B) having an LOI-value of at least 25, a thermal shrinkage ratio at 180° C. of at most 5%, and a single fiber fineness of 20 to 100 dtex.

2. The fiber bundle for hair use of claim 1, wherein the component (B) is polyester fibers formed from a composition obtained by melt-kneading polyalkylene terephthalate and a copolymered polyester comprising polyalkylene terephthalate as the main component (C) with a phosphorus flame retardant (D) and/or a bromine flame retardant (E).

3. The fiber bundle for hair use of claim 1, wherein said component (C) is at least one of a polymer selected from the group consisting of polyethylene terephthalate, polypropylene terephthalate, polybutylene terephthalate, a polyester in which ethylene glycol ether of bisphenol-A is copolymerized, a polyester in which 1,4-cyclohexane dimethanol is copolymerized, a polyester in which dihydroxyethyl 5-sodium sulfoisophthalate is copolymerized, a polymer alloy of polyethylene terephthalate and polyethylene naphthalate, a polymer alloy of polyethylene terephthalate and polyarylate, and a polymer alloy of polyethylene terephtharate and polycarbonate.

4. The fiber bundle for hair use of claim 1, wherein said component (D) is at least one compound selected from the group consisting of a phosphate compound, a phosphonate compound, a phosphinate compound, a phosphine oxide compound, a phosphonite compound, a phosphinite compound, a phosphine compound, a condensed phosphoric ester compound, a phosphoric ester amide compound, and an organic cyclic phosphorus compound.

5. The fiber bundle for hair use of claim 1, wherein said component (E) is at least one compound selected from the group consisting of a bromine-containing phosphoric ester flame retardant, a brominated polystyrene flame retardant, a brominated benzylacrylate flame retardant, a brominated epoxy flame retardant, a brominated polycarbonate flame retardant, a derivative of tetrabromobisphenol-A, a bromine-containing triazine compound, and a bromine-containing isocyanuric acid compound.

6. The fiber bundle for hair use of claim 1, wherein said component (B) has fine projections on the surface of the fiber comprising a mixture of organic fine particles (F) and/or inorganic fine particles (G).

7. The fiber bundle for hair use of claim 6, wherein said component (F) is at least one selected from the group consisting of polyarylate, polyamide, fluorine resin, a silicone resin, a crosslinked acrylic resin, and crosslinked polystyrene.

8. The fiber bundle for hair use of claim 6, wherein said component (G) is at least one selected from the group consisting of calcium carbonate, silicon oxide, titanium oxide, aluminum oxide, zinc oxide, talc, kaolin, montmorillonite, bentonite, and mica.

9. A head decoration product, which is obtained by processing the fiber bundle for hair use of claim 1.

10. The head decoration product of claim 9, which is a wig or a hair accessory.
